(19) United States
(12) Patent Application Publication
(10) Pub. No.: US 2024/0428551 A1
(43) Pub. Date: Dec. 26, 2024

(54) IMAGE PROCESSING SYSTEM

(71) Applicant: NEC Corporation, Minato-ku, Tokyo (JP)

(72) Inventor: Jun PIAO, Tokyo (JP)

(73) Assignee: NEC Corporation, Minato-ku, Tokyo (JP)

(21) Appl. No.: 18/698,418

(22) PCT Filed: Oct. 26, 2021
(86) PCT No.: PCT/JP2021/039520

§ 371 Date: Apr. 4, 2024

(51) Int. Cl. G06V 10/44; G06V 10/80

(52) U.S. Cl. CPC G06V 10/44; G06V 10/806; G06V 2201/07

(57) ABSTRACT

An image processing system includes a training unit that generates a trained model performing a plurality of mutually different inference tasks from an image. The trained model includes: a first component that extracts a first feature value common to the plurality of inference tasks from the image; a second component that is provided for each of the inference tasks and extracts a second feature value specific to the corresponding inference task from the first feature value; a third component that generates a third feature value by concatenating the second feature values extracted for the respective inference tasks; and a fourth component that is provided for each of the inference tasks and outputs an inference result of the corresponding inference task from the third feature value.

### TECHNICAL FIELD

The present invention relates to an image processing system, an image processing method, and a recording medium.

### BACKGROUND ART

There is a method of simultaneously learning and estimating a plurality of tasks using a single multilayer neural network DNN (Deep Neural Network). This method is called multitask learning. Multitask learning can reduce learning and estimation time, which increases in proportion to the number of tasks. This makes multitask learning an effective method for an application such as human image analysis that requires information obtained from a plurality of tasks.

An example of multitask learning is described in Patent Literature 1. In a technique described in Patent Literature 1 (hereinafter referred to as the technique related to the present invention), a DNN extracts a feature value x^{L} common to a plurality of tasks from an image showing a person's face. Next, the DNN extracts a feature value specific to a task of identifying a facial expression from the feature value x^{L} and outputs an estimation result y^{c} and, in parallel, the DNN extracts a feature value specific to a task of estimating the positions of the eyes and nose in a facial region from the feature value x^{L} and outputs an estimation result y^{r}.

### CITATION LIST

### Patent Literature Patent Literature 1: Japanese Unexamined Patent Application Publication No. JP-A 2018-055377

### SUMMARY OF INVENTION

### Technical Problem

However, in the technique related to the present invention, a feature value common to all the tasks is extracted from an image, and a task-specific feature value is extracted from this common feature value and the estimation result of the task is estimated. Therefore, there is a problem that a feature value specific to one task cannot be used for estimation of the other tasks.

### Solution to Problem

The present invention is to provide an image processing system that solves the abovementioned problem, namely, a problem that task-specific feature values cannot be shared among a plurality of tasks.

An image processing system according to an aspect of the present invention includes a training unit that generates a trained model performing a plurality of mutually different inference tasks from an image, and the trained model includes: a first component that extracts a first feature value common to the plurality of inference tasks from the image; a second component that is provided for each of the inference tasks and extracts a second feature value specific to the corresponding inference task from the first feature value; a third component that generates a third feature value by concatenating the second feature values extracted for the respective inference tasks; and a fourth component that is provided for each of the inference tasks and outputs an inference result of the corresponding inference task from the third feature value.

An image processing system according to another aspect of the present invention includes an inferring unit that outputs inference results of a plurality of mutually different inference tasks from an image by using a trained model, and the trained model includes: a first component that extracts a first feature value common to the plurality of inference tasks from the image; a second component that is provided for each of the inference tasks and extracts a second feature value specific to the corresponding inference task from the first feature value; a third component that generates a third feature value by concatenating the second feature values extracted for the respective inference tasks; and a fourth component that is provided for each of the inference tasks and outputs an inference result of the corresponding inference task from the third feature value.

An image processing method according to another aspect of the present invention includes: generating a trained model performing a plurality of mutually different inference tasks from an image; and, in the generation, causing the trained model to: extract a first feature value common to the plurality of inference tasks from the image; extract, for each of the inference tasks, a second feature value specific to the corresponding inference task from the first feature value; generate a third feature value by concatenating the second feature values extracted for the respective inference tasks; and output, for each of the inference tasks, an inference result of the corresponding inference task from the third feature value.

An image processing method according to another aspect of the present invention includes: estimating and outputting inference results of a plurality of mutually different inference tasks from an image by using a trained model; and, in the estimation, causing the trained model to: extract a first feature value common to the plurality of inference tasks from the image; extract, for each of the inference tasks, a second feature value specific to the corresponding inference task from the first feature value; generate a third feature value by concatenating the second feature values extracted for the respective inference tasks; and output, for each of the inference tasks, an inference result of the corresponding inference task from the third feature value.

A computer-readable recording medium according to another aspect of the present invention is a non-transitory computer-readable recording medium on which a program is recorded, and the program includes instructions for causing a computer to perform processes to: generate a trained model performing a plurality of mutually different inference tasks from an image; and, in the generation, cause the trained model to: extract a first feature value common to the plurality of inference tasks from the image; extract, for each of the inference tasks, a second feature value specific to the corresponding inference task from the first feature value; generate a third feature value by concatenating the second feature values extracted for the respective inference tasks; and output, for each of the inference tasks, an inference result of the corresponding inference task from the third feature value.

A computer-readable recording medium according to another aspect of the present invention is a non-transitory computer-readable recording medium on which a program is recorded, and the program includes instructions for causing a computer to perform processes to: estimate and output inference results of a plurality of mutually different inference tasks from an image by using a trained model; and, in the estimation, causing the trained model to: extract a first feature value common to the plurality of inference tasks from the image; extract, for each of the inference tasks, a second feature value specific to the corresponding inference task from the first feature value; generate a third feature value by concatenating the second feature values extracted for the respective inference tasks; and output, for each of the inference tasks, an inference result of the corresponding inference task from the third feature value.

### Advantageous Effects of Invention

With the configurations as described above, the present invention allows for share of task-specific feature values among a plurality of tasks. Consequently, in each of the plurality of tasks, learning and estimation can be performed in consideration of a feature value specific to the task and feature values specific to the other tasks.

### BRIEF DESCRIPTION OF DRAWINGS

FIG. 1 a block diagram of an information processing apparatus according to a first example embodiment of the present invention.

FIG. 2 is a flowchart showing an example of operation in a learning phase in the image processing apparatus according to the first example embodiment of the present invention.

FIG. 3 is a flowchart showing an example of operation in an estimation phase in the image processing apparatus according to the first example embodiment of the present invention.

FIG. 4 is a configuration diagram showing an example of a model used in the first example embodiment of the present invention.

FIG. 5 is a configuration diagram showing an example of a component CM3 of the model used in the first example embodiment of the present invention.

FIG. 6 is configuration diagram showing another example of the component CM3 of the model used in the first example embodiment of the present invention.

FIG. 7 is a view showing an example of a list of training data used in machine learning of the model used in the first example embodiment of the present invention.

FIG. 8 is a flowchart showing an example of a training process by a training unit in the image processing apparatus according to the first example embodiment of the present invention.

FIG. 9 is a block diagram of an image processing apparatus according to a second example embodiment of the present invention.

FIG. 10 is a block diagram of an image processing apparatus according to a third example embodiment of the present invention.

### DESCRIPTION OF EMBODIMENTS

Next, example embodiments of the present invention will be described in detail with reference to the drawings.

### [First Example Embodiment]

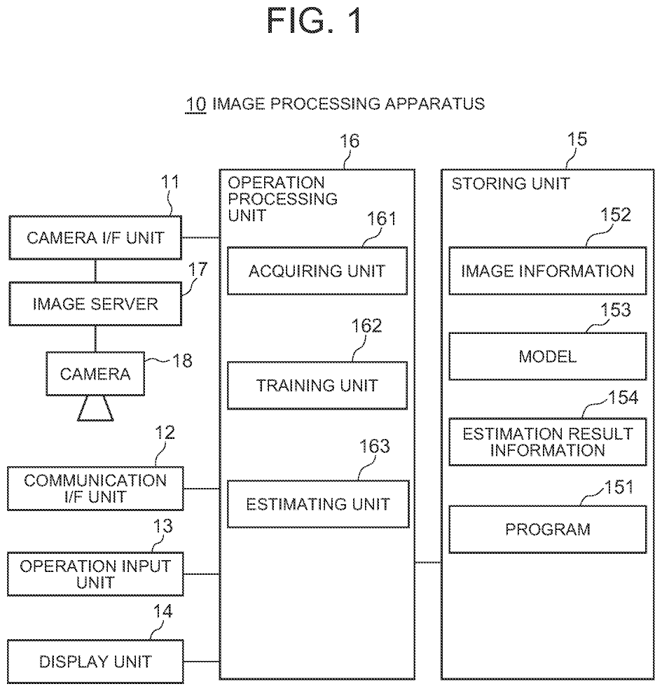

FIG. 1 is a block diagram of an image processing apparatus 10 according to a first example embodiment of the present invention. The image processing apparatus 10 is configured to perform a plurality of mutually different inference tasks from an image. Referring to FIG. 1, the image processing apparatus 10 includes a camera I/F (interface) unit 11, a communication I/F unit 12, an operation input unit 13, a screen display unit 14, a storing unit 15, and an operation processing unit 16.

The camera I/F unit 11 is connected to an image server 17 by wire or wirelessly, and is configured to transmit and receive data to and from the image server 17 and the operation processing unit 16. The image server 17 is connected to a camera 18 by wire or wirelessly, and is configured to accumulate a plurality of images captured by the camera 18 at different shooting times, for a certain period of time in the past. The camera 18 may be, for example, a color camera or a monochrome camera equipped with a CCD (Charge-Coupled Device) image sensor or a CMOS (Complementary MOS) image sensor having a pixel capacity about several million pixels. The camera 18 may be a camera installed on a street, indoors or the like where many people pass by, for the purpose of security and surveillance purposes. Alternatively, the camera 18 may be a camera that is mounted on a moving body such as a car to capture the same or different shooting regions while moving. The camera 18 is not limited to one camera, and may be a plurality of cameras that capture different shooting regions from different locations.

The communication I/F unit 12 is configured with a data communication circuit, and is configured to perform data communication with an external device, which is not shown, by wire or wirelessly. The operation input unit 13 is configured with an operation input device such as a keyboard and a mouse, and is configured to detect an operator's operation and output to the operation processing unit 16. The screen display unit 14 is configured with a screen display device such as an LCD (Liquid Crystal Display), and is configured to display a variety of information on a screen in response to an instruction from the operation processing unit 16.

The storing unit 15 is configured with a storage device such as a hard disk and a memory, and is configured to store processing information necessary for a variety of processing by the operation processing unit 16 and a program 151. The program 151 is a program loaded and executed by the operation processing unit 16 to implement various processing units, and is loaded in advance from an external device or a recording medium, which is not shown, via a data input/output function such as the communication I/F unit 12 and stored in the storing unit 15. Main processing information stored in the storing unit 15 includes image information 152, a model 153, and estimation result information 154.

The image information 152 is a frame image of the camera 18 acquired from the image server 17 through the camera I/F unit 11.

The model 153 is a machine learning model that learns and estimates a plurality of different inference tasks simultaneously from the frame image of the camera 18. The model 153 may be configured, for example, using a DCNN (Deep Convolutional Neural Network). In this example embodiment, the model 153 learns parameters to perform three inference tasks: object detection, pose estimation, and semantic segmentation estimation. A model having learned parameters is referred to as a trained model, and is distinguished from a model before learning.

Objection detection is to detect a class and an object position in an image. The result of object detection includes the name of the class, the estimation reliability level of the class, and a bounding box (hereinafter referred to as a rectangle) representing an object position. A class to be detected may be, for example, a person. However, a class to be detected is not limited to a person, and may be an animal or a thing.

Pose estimation is to estimate the skeletal information of a person in an image. The skeletal information of a person includes information representing the positions of joints that make up the body of the person. The joints may include not only joints such as neck and shoulders, but also facial parts such as eyes and nose. The result of pose estimation includes the names of the joints (joint IDs), the positions of the joints, and the reliability levels of the joints.

Semantic segmentation estimation is to estimate the class of each pixel in an image. The result of semantic segmentation estimation includes the class of each pixel. The class to be estimated is the same as the class to be detected in object detection.

The estimation result information 154 is information representing a result estimated from an image using the trained model 153. The estimation result information 154 includes the object detection result, the pose estimation result, and the semantic segmentation estimation result.

The operation processing unit 16 has one or more processors such as MPU and a peripheral circuit thereof, and is configured to load the program 151 from the storing unit 15 and execute to cause the abovementioned hardware and the program 151 to cooperate with each other and implement various processing units. Main processing units realized by the operation processing unit 16 include an acquiring unit 161, a training unit 162, and an estimating unit 163.

The acquiring unit 161 is configured to acquire a frame image constituting a moving image captured by the camera 18 or a frame image obtained by downsampling the above frame image from the image server 17 through the camera I/F unit 11, and store as the image information 152 into the storing unit 15. A camera ID and the shooting time are added to the acquired frame image. The shooting time of a frame image differs from frame to frame.

The training unit 162 is configured to make the model 153 simultaneously learn the abovementioned three inference tasks using training data. That is to say, the training unit 162 generates the trained model 153 that performs the abovementioned three inference tasks from an image. In the above generation, the training unit 21 makes the model 153: extract a first feature value that is common to the abovementioned three inference tasks from an image; then extract, for each of the inference tasks, a second feature value that is specific to the inference task from the first feature value; then generate a third feature value by concatenating the second feature values extracted for the respective inference tasks; and then output, for each of the inference tasks, the inference result of the inference task from the third feature value.

The estimating unit 163 is configured to, using the trained model 153, estimate the inference results of the abovementioned three inference tasks from the image and output the inference results. In the above estimation, the estimating unit 31 makes the trained model 153: first extract a first feature value that is common to the abovementioned three inference tasks from an image; then extract, for each of the inference tasks, a second feature value that is specific to the inference task from the first feature value; then generate a third feature value by concatenating the second feature values extracted for the respective inference tasks; and then output, for each of the inference tasks, the inference result of the inference task from the third feature value.

Next, the operation of the image processing apparatus 10 will be described. The phase of the image processing apparatus 10 is roughly divided into a learning phase and an estimation phase. The learning phase is a phase of making the model 153 perform machine learning. The estimation phase is a phase of, by using the trained model 153, estimating the inference results of the abovementioned three inference tasks from an image and outputting the inference results.

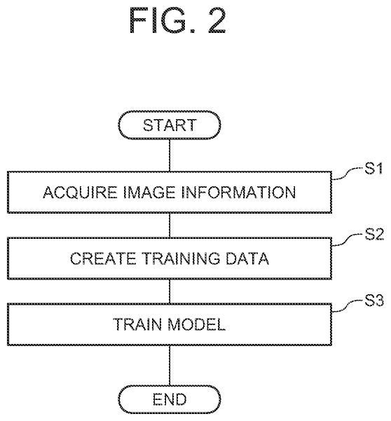

FIG. 2 is a flowchart showing an example of the operation of the learning phase. Referring to FIG. 2, first, the acquiring unit 161 acquires a frame image captured by the camera 18 from the image server 17 through the camera I/F unit 11, and stores the frame image as the image information 152 into the storing unit 15 (step S1). Next, the training unit 162 creates training data to be used for machine learning of the model 153 (step S2). Next, the training unit 162 causes the model 153 with the image as input and the estimation results of the abovementioned three inference tasks as output to perform machine learning using the training data, and generates the trained model 153 (step S3).

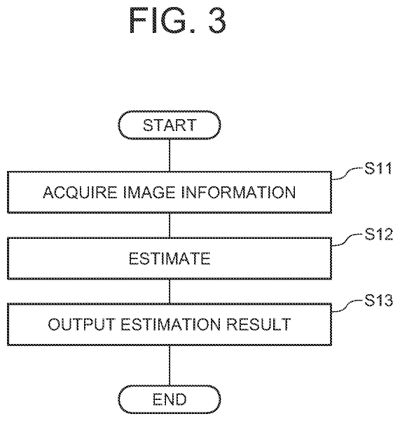

FIG. 3 is a flowchart showing an example of the operation of the estimation phase. Referring to FIG. 3, first, the acquiring unit 161 acquires a frame image captured by the camera 18 from the image server 17 through the camera I/F unit 110, and stores the frame image as the image information 152 into the storing unit 15 (step S11).

Next, the estimating unit 163 simultaneously estimates the estimation results of the abovementioned three inference tasks from the frame image included by the image information 152 using the trained model 153 (step S12). Next, the estimating unit 163 causes the screen display unit 14 to display the estimation results of the three inference tasks having been estimated, and/or transmits the estimation results to an external device through the communication I/F unit 12 (step S13).

Subsequently, the model 153 and the training unit 162 will be described in detail.

First, the details of the model 153 will be described.

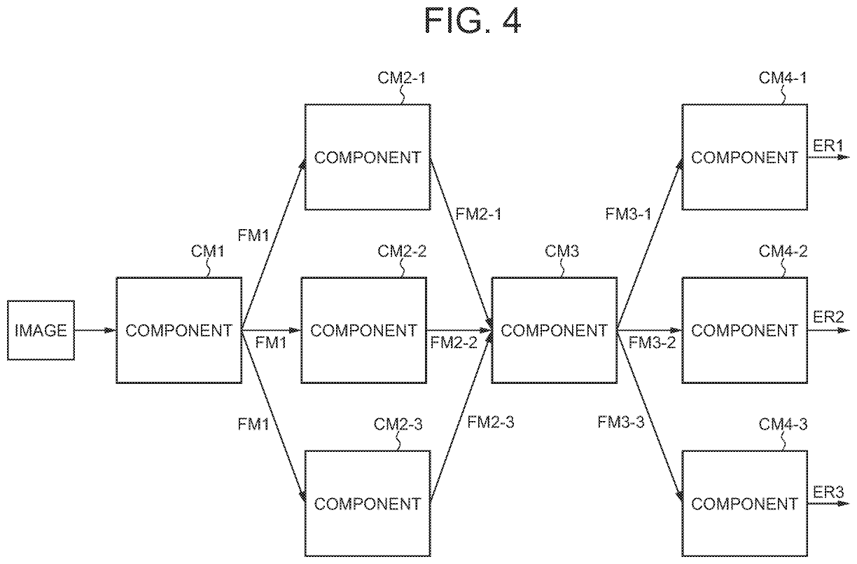

FIG. 4 is a configuration diagram showing an example of a multitask model that can be used as the model 153. The model 153 in this example includes eight components CM, and is totally a single multilayer neural network.

A component CM1 is provided on the lower layer side of the multilayer neural network, and is configured to obtain input of an image and extract a low-order feature value FM1 that is common to all the tasks. The component CM1 is also called a backbone. The feature value FM1 extracted by the component CM1 is also referred to as a low-order feature map. The component CM1 may include one or more convolution layers. For example, the component CM1 may use VGG-16 that is a component of SSD (Single Shot MultiBox Detector). Alternatively, the component CM1 may use, for example, VGG-19 that is a component of OpenPose. Alternatively, the component CM1 may use, for example, an encoder that is a component of SegNet. Alternatively, the component CM1 may use, for example, a backbone of a model other than SSD, OpenPose or SegNet.

A component CM2-1 is configured to obtain input of the feature value FM1 from the component CM1 and extract a high-order feature value FM2-1 that is specific to the object detection task. The component CM2-1 may include one or more convolution layers. For example, the component CM2-1 may use a special convolution layer (Extra Feature Layers) that is a component of SSD. However, the component CM2-1 is not limited to the above, and may be use a convolution layer that extracts a high-order feature value that is specific to the object detection task in an object detection model other than SSD.

A component CM2-2 is configured to obtain input of the feature value FM1 from the component CM1, and extract a high-order feature value FM2-2 that is specific to the pose estimation task. The component CM2-2 may include one or more convolution layers. For example, the component CM2-2 may use the components of OpenPose; a convolution layer that generates Part Confidence Map representing the positions of key points, a convolution layer that generates Part Affinity Fields representing the association level between the key points, and a layer that concatenates the generated Part Confidence Map and Part Affinity Fields and the extraction source feature value FM1 (a feature map thus obtained by the concatenation will be referred to as OpenPose feature map hereinafter). However, the component CM2-2 is not limited to the above, and may use a convolution layer that extracts a high-order feature value specific to the pose estimation task in a pose estimation model other than OpenPose.

A component CM2-3 is configured to obtain input of the feature value FM1 from the component CM1 and extract a high-order feature value FM2-3 that is specific to the semantic segmentation estimation task. The component CM2-3 may include one or more convolution layers. For example, the component CM2-3 may use a decoder that is a component of SegNet. However, the component CM2-3 is not limited to the above, and may use a convolution layer that extracts a high-order feature value specific to the semantic segmentation estimation task in a semantic segmentation estimation model other than SegNet.

A component CM3 is configured to obtain input of the feature values FM2-1, FM2-2 and FM2-3 from the components CM2-1, CM2-2 and CM-2-3, and generate feature values FM3-1, FM3-2 and FM3-3 obtained by concatenating the three feature values FM2-1, FM2-2 and FM2-3.

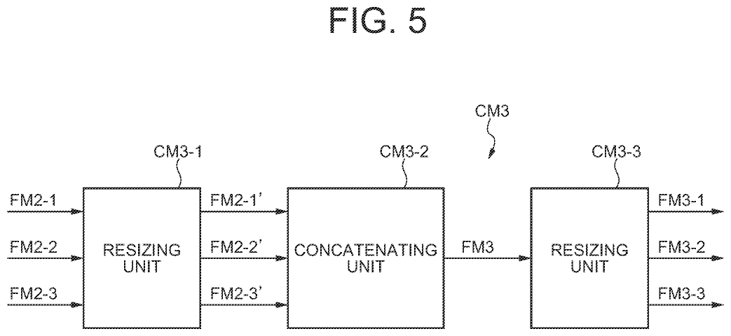

FIG. 5 is a configuration diagram showing an example of the component CM3. The component CM3 in this example includes a resizing unit CM3-1, a concatenating unit CM3-2, and a resizing unit CM3-3.

The resizing unit CM3-1 is configured to match the sizes of the feature values FM2-1, FM2-2 and FM2-3 so that the feature values can be concatenated. The resizing unit CM3-1 sets any one of the three feature values as a reference feature value, and changes the sizes of the remaining two feature values so as to match the size of the reference feature value. For example, a case will be assumed where the sizes of the feature values FM2-1, FM2-2 and FM2-3 are 38×38, 70×70 and 240×320, respectively, and the reference feature value is the feature value FM2-1. In this case, the resizing unit CM3-1 generates and outputs a feature value FM2-2′ obtained by changing the size of the feature value FM2-2 from 70×70 to 38×38. The resizing unit CM3-1 also generates and outputs a feature value FM2-3′ obtained by changing the size of the feature value FM2-3 from 240×320 to 38×38. The resizing unit CM3-1 does not change the size of the feature value FM2-1, and outputs the feature value FM2-1 as it is as a feature value FM2-1′.

The concatenating unit CM3-2 obtains input of the feature values FM2-1′, FM2-2′ and FM2-3′ from the resizing unit CM3-1, and generates and outputs a feature value FM3 obtained by concatenating the feature values. For example, the concatenating unit CM3-2 obtains input of the feature values FM2-1′, FM2-2′ and FM2-3′ each having a size of 38×38, and generates and outputs the feature value FM3 having a size of 38×38×3. Thus, the number of channels (number of dimensions) increases with the concatenation of the feature values.

The resizing unit CM3-3 obtains input of the feature value FM3 from the concatenating unit CM3-2, and generates and outputs feature values FM3-1, FM3-2 and FM3-3 obtained by changing the size to sizes appropriate for the respective tasks. For example, a case will be assumed where the input sizes of components CM4-1, CM4-2 and CM4-3 are 38×38×3, 70×70×3 and 240×320×3, respectively. In this case, the resizing unit CM3-3 generates the feature value FM3-2 obtained by changing the size of the feature value FM3 from 38×38×3 to 70×70×3, and outputs the feature value FM3-2 to the component CM4-2. The resizing unit CM3-3 also generates the feature value FM3-3 obtained by changing the size of the feature value FM3 from 38×38×3 to 240×320×3, and outputs the feature value FM3-3 to the component CM4-3. The resizing unit CM3-3 also outputs the feature value FM3 having a size of 38×38×3 as it is as the feature value FM3-1 to the component CM4-1.

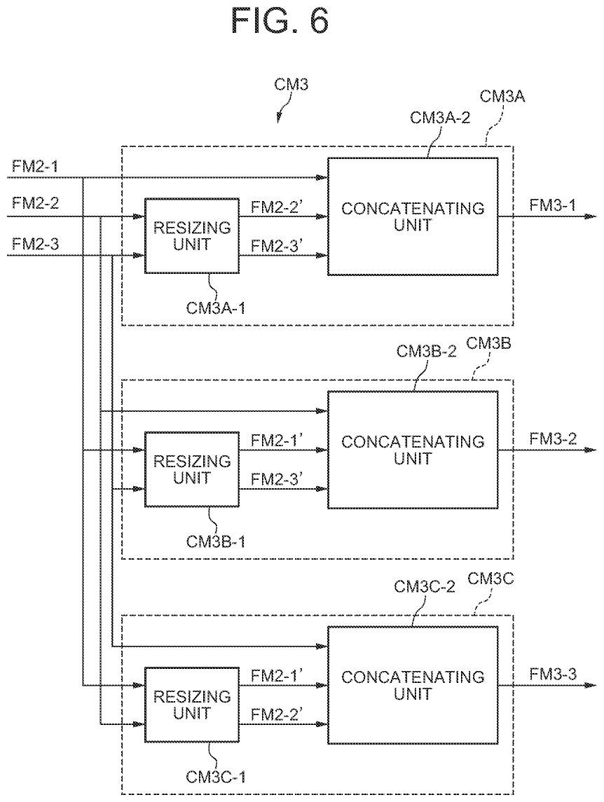

FIG. 6 is a configuration diagram of another example of the component CM3. The component CM3 in this example includes three subcomponents CM3A, CM3B, and CM3C.

The subcomponent CM3A is configured to generate the feature value FM3-1 for the component CM4-1 of the object detection task from the feature values FM2-1, FM2-2 and FM2-3 and outputs the feature value FM3-1. The subcomponent CM3A includes a resizing unit CM3A-1 that generates and outputs feature values FM2-2′ and FM2-3′ obtained by changing the size of the feature values FM2-2 and FM2-3 so as to match the size of the feature value FM2-1, and a concatenating unit CM3A-2 that generates and outputs the feature FM3-1 obtained by concatenating the three feature values FM2-1, FM2-2′ and FM2-3′. For example, a case will be assumed where the sizes of the feature values FM2-1, FM2-2 and FM2-3 are 38×38, 70×70 and 240×320, respectively, and the input size of the component CM4-1 is 38×38×3. In this case, the resizing unit CM3A-1 generates and outputs the feature value FM2-2′ obtained by changing the size of the feature value FM2-2 from 70×70 to 38×38, and generates and outputs the feature value FM2-3′ obtained by changing the size of the feature value FM2-3 from 240×320 to 38×38. The concatenating unit CM3A-2 concatenates the feature values FM2-1, FM2-2′ and FM2-3′ having the same size of 38×38, and generates and outputs the feature value FM3-1 having a size of 38×38×3. This makes it possible to suppress deterioration of the feature value FM2-1 due to the concatenation.

The subcomponent CM3B is configured to generate the feature value FM3-2 for the component CM4-2 of the pose estimation task from the feature values FM2-1, FM2-2 and FM2-3 and output the feature value FM3-2. The subcomponent CM3B includes a resizing unit CM3B-1 that generates and outputs feature values FM2-1′ and FM2-3′ obtained by changing the sizes of the feature values FM2-1 and FM2-3 so as to match the size of the feature value FM2-2, and a concatenating unit CM3B-2 that generates and outputs the feature value FM3-2 obtained by concatenating the three feature values FM2-1′, FM2-2 and FM2-3′. For example, a case will be assumed where the sizes of the feature values FM2-1, FM2-2 and FM2-3 are 38×38, 70×70 and 240×320, respectively, and the input size of the component CM4-2 is 70×70×3. In this case, the resizing unit CM3B-1 generates and outputs the feature value FM2-1′ obtained by changing the size of the feature value FM2-1 from 38×38 to 70×70, and generates and outputs the feature value FM2-3′ obtained by changing the size of the feature value FM2-3 from 240×320 to 70×70. The concatenating unit CM3B-2 concatenates the feature values FM2-1′, FM2-2 and FM2-3′ having the same size of 70×70, and generates and outputs the feature value FM3-2 having a size of 70×70×3. This makes it possible to suppress deterioration of the feature value FM2-2 due to the concatenation.

The subcomponent CM3C is configured to generate the feature value FM3-3 for the component CM4-3 of the semantic segmentation estimation task from the feature values FM2-1, FM2-2 and FM2-3, and output the feature value FM3-3. The subcomponent CM3C includes a resizing unit CM3C-1 that generates and outputs the feature values FM2-1′ and FM2-2′ obtained by changing the sizes of the feature values FM2-1 and FM2-2 so as to match the size of the feature value FM2-3, and a concatenating unit CM3C-2 that generates and outputs the feature FM3-3 obtained by concatenating the three feature values FM2-1′, FM2-2′ and FM2-3. For example, a case will be assumed where the sizes of the feature values FM2-1, FM2-2 and FM2-3 are 38×38, 70×70 and 240×320, respectively, and the input size of the component CM4-3 is 240×320×3. In this case, the resizing unit CM3C-1 generates and outputs the feature value FM2-1′ obtained by changing the size of the feature value FM2-1 from 38×38 to 240×240, and generates and outputs the feature value FM 2-2′ obtained by changing the size of the feature value FM2-2 from 70×70to 240×320. The concatenating unit CM3C-2 concatenates the feature values FM2-1′, FM2-2′ and FM2-3 having the same size of 240×320, and generates and outputs the feature value FM3-3 having a size of 240×320×3. This makes it possible to suppress deterioration of the feature value FM2-3 due to the concatenation.

Referring again to FIG. 4, the component CM4-1 is configured to obtain input of the feature value FM3-1 from the component CM3, estimate an estimation result ER1 of the object detection task from the feature value FM3-1, and output the estimation result ER1. The feature value FM3-1 includes, not only the high-order feature value FM2-1 specific to the object detection task, but also the high-order feature value FM2-2 specific to the pose estimation task and the high-order feature value FM2-3 specific to the semantic segmentation estimation. Consequently, the component CM4-1 can perform learning and estimation in consideration of the three high-order feature values. The component CM4-1 may use, for example, an output layer (Detections: 8732 per Class, Non-Maximum Suppression) connected to the special convolution layer that constitutes SSD.

Here, the component CM4-1 may set a weight that determines the priority level of the high-order feature value FM2-1 specific to the object detection task to be larger than a weight that determines the priority levels of second feature values other than the feature value FM2-1. For example, the component CM4-1 may set a weight that determines the priority level of the high-order feature value FM2-1 specific to the object detection task to 0.5, and set a weight that determines the priority levels of the second feature values other than the feature value FM2-1 to 0.25. By thus giving a relatively large weight to the feature value FM2-1, it is possible to raise the importance level of the high-order feature value FM2-1 specific to the object detection task while enabling learning and estimation in consideration of the three high-order feature values.

Further, the component CM4-1 may perform 1×1 convolution (Channel-Wise Convolution) on the input feature value FM3-1 to reduce the number of dimensions of the high-order feature value, for example, from 38×38×3 to 38×38×1. Consequently, it is possible to use, as the component CM4-1, a network part estimating an estimation result from high-order feature values and outputting the estimation result in an existing model such as SSD.

The component CM4-2 is configured to obtain input of the feature value FM3-2 from the component CM3, estimate an estimation result ER2 of the pose estimation task from the feature value FM3-2, and output the estimation result ER2. The feature value FM3-2 includes, not only the high-order feature value FM2-2 specific to the pose estimation task, but also the high-order feature value FM2-1 specific to the object detection task and the high-order feature value FM2-3 specific to the semantic segmentation estimation. Consequently, the component CM4-2 can perform learning and estimation in consideration of the three high-order feature values. The component CM4-2 may use, for example, a network part that estimates a pose estimation result from the OpenPose feature map, which is a component of OpenPose.

Here, the component CM4-2 may set a weight that determines the priority level of the high-order feature value FM2-2 specific to the pose estimation task to be larger than a weight that determines the priority levels of second feature values other than the feature value FM2-2. For example, the component CM4-2 may set a weight that determines the priority level of the high-order feature value FM2-2 specific to the pose estimation task to 0.5, and set a weight that determines the priority level of second feature values other than the feature value FM2-2 to 0.25. By thus giving a relatively large weight to the feature value FM2-2, it is possible to raise the importance level of the high-order feature value FM2-2 specific to the pose estimation task while enabling learning and estimation in consideration of the three high-order feature values.

Further, the component CM4-2 may perform 1×1 convolution (Channel-Wise Convolution) on the input feature value FM3-2 to reduce the number of dimensions of the high-order feature value, for example, from 70×70×3 to 70×70×1. Consequently, it is possible to use, as the component CM4-2, a network part estimating an estimation result from high-order feature values and outputting the estimation result in an existing model such as OpenPose.

The component CM4-3 is configured to obtain input of the feature value FM3-3 from the component CM3, estimate an estimation result ER3 of the semantic segmentation estimation task from the feature value FM3-3, and output the estimation result ER3. The feature value FM3-3 includes, not only the high-order feature value FM2-3 specific to the semantic segmentation estimation task, but also the high-order feature value FM2-1 specific to the object detection task and the high-order feature value FM2-2 specific to the pose estimation. Consequently, the component CM4-3 can perform learning and estimation in consideration of the three high-order feature values. The component CM4-3 may be, for example, a softmax layer that is a component of SegNet.

Here, the component CM4-3 may set a weight that determines the priority level of the high-order feature value FM2-3 specific to the semantic segmentation estimation task to be larger than a weight that determines the priority levels of second feature values other than the feature value FM2-3. For example, the component CM4-3 may set a weight that determines the priority level of the high-order feature value FM2-3 specific to the semantic segmentation estimation task to 0.5, and set a weight that determines the priority levels of second feature values other than the feature value FM2-3 to 0.25. By thus giving a relatively large weight to the feature value FM2-3, it is possible to raise the importance level of the high-order feature value FM2-3 specific to the semantic segmentation estimation task while enabling learning and estimation in consideration of the three high-order feature values.

Further, the component CM4-3 may perform 1×1 convolution (Channel-Wise Convolution) on the input feature value FM3-3 to reduce the number of dimensions of the high-order feature value, for example, from 240×320×3 to 240×320×1. Consequently, it is possible to use, as the component CM4-3, a network part estimating an estimation result from high-order feature values and outputting the estimation result in an existing model such as SegNet.

Subsequently, the details of the training unit 162 will be described.

First, training data used in machine learning of the model 153 will be described.

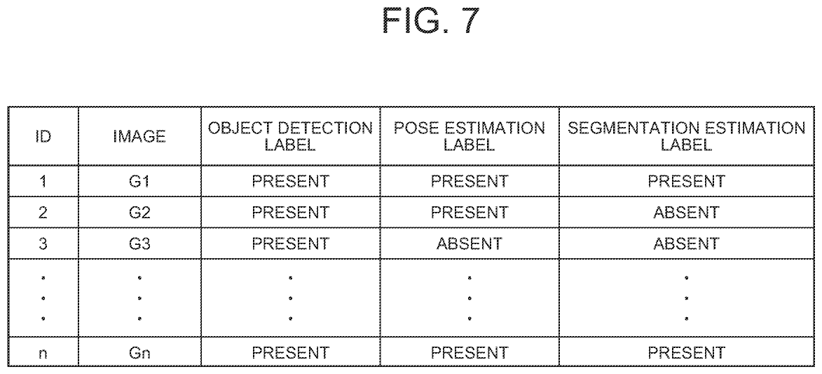

FIG. 7 shows an example of a list of training data used in machine learning of the model 153. Referring to FIG. 7, a total of n pieces of training data are registered in this list. Each piece of training data is composed of items such as ID uniquely identifying the training data, image, object detection label, pose estimation label, and semantic segmentation estimation label.

A frame image captured by the camera 18 is set in the item of image. In the item of object detection label, the presence or absence of the label is set and, in a case where the label is present, label information, namely, a class such as person existing in the image and position information thereof (rectangle information) are set. In the item of pose estimation label, the presence or absence of the label is set and, in a case where the label is present, the joint name (joint ID) of a joint existing in the image and position information thereof are set. In the item of semantic segmentation estimation label, the presence or absence of the label is set and, in a case where the label is present, the class of each pixel of the image is set. Thus, the training data set may include, in addition to training data in which the label information is set in the items of all the three labels (object detection label, pose estimation label, and semantic segmentation estimation label), training data in which the label information is set in the items of only some of the labels.

The training data as described above may be created, for example, through interactive processing with a user. For example, the training unit 162 causes the screen display unit 14 to display an image captured by the camera 18 acquired by the acquiring unit 161, and receives the label information of the image from the user through the operation input unit 13. The training unit 162 then creates the set of the displayed image and the received label information as one training data. The training unit 162 creates a necessary and sufficient number of training data by the same method. However, the method of creating the training data is not limited to the above.

Next, a method by which the training unit 162 trains the model 153 using the training data will be described.

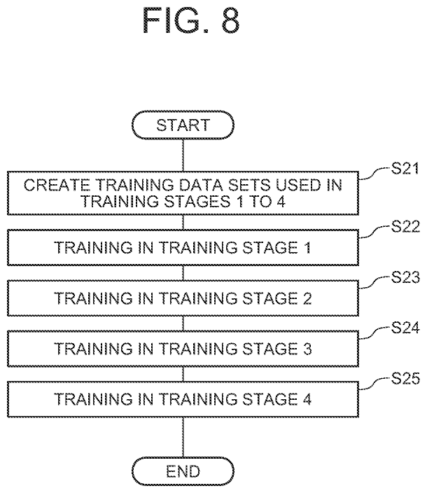

FIG. 8 is a flowchart showing an example of a training process by the training unit 162. In the training process of this example, the model 153 with the configuration shown in FIG. 4 is a training target model. Moreover, in the training process of this example, the entire model 153 is not trained at once, but the model 153 is trained while a network part to be trained is gradually expanded. This allows for stable learning. Specifically, it goes through the following four training stages.

### (1) Training Stage 1

In a training stage 1, the training unit 162 trains only the components CM2-1 and CM4-1 that are deep-layer network parts related to object detection. At this time, the parameters of the backbone component CM-1, the components CM2-2 and CM4-2 that are deep-layer network parts related to pose estimation, and the components CM2-3 and CM4-3 that are deep-layer network parts related to semantic segmentation estimation are fixed.

### (2) Training Stage 2

In a training stage 2, the training unit 162 trains only the components CM2-1, CM2-2, CM4-1, and CM4-2 that are deep-layer network parts related to object detection and pose estimation. At this time, the parameters of the backbone component CM-1 and the components CM2-3 and CM4-3 that are deep-layer network parts related to semantic segmentation estimation are fixed.

### (3) Training Stage 3

In a training stage 3, the training unit 162 trains only the components CM2-1, CM2-2, CM2-3, CM4-1, CM4-2, and CM4-3 that are deep-layer network parts related to all the inference tasks, that is, object detection, pose estimation, and semantic segmentation estimation. At this time, the parameter of the backbone component CM-1 is fixed.

### (4) Training Stage 4

In a training stage 4, the training unit 162 trains the entire model, that is, the backbone component CM-1 and the components CM2-1, CM2-2, CM2-3, CM4-1, CM4-2, and CM4-3 that are deep-layer network parts related to object detection, pose estimation, and semantic segmentation estimation.

Referring to FIG. 8, the training unit 162 creates a training data set to be used in the respective training stages from the training data set used in machine learning of the model 153 (step S21).

For example, at step S21, the training unit 162 creates a training data set to be used in the training stage 3 and a training data set to be used in the training stage 4 that include a necessary number of training data, respectively, from the list of training data as described in FIG. 7. The training stage 3 and the training stage 4 require training data in which the label information is set in all the items of the three labels (object detection label, pose estimation label, and semantic segmentation estimation label). Therefore, the training unit 162 extracts training data that satisfies such a condition from the list and thereby creates a training data set to be used in the training stage 3 and a training data set to be used in the training stage 4.

Further, at step S21, the training unit 162 creates a training data set to be used in the training stage 2 from the rest of the training data set in the list. The training stage 2 requires training data in which the label information is set in the items of the object detection label and the pose estimation label (it is irrelevant whether semantic segmentation estimation label information is present or absent). Therefore, the training unit 162 extracts training data that satisfies such a condition from the list and thereby creates a training data set to be used in the training stage 2.

Further, at step S21, the training unit 162 creates a training data set to be used in the training stage 1 from the rest of the training data set in the list. The training stage 1 requires training data in which the label information is set in the item of the object detection label (it is irrelevant whether the pose estimation label information and the semantic segmentation estimation label information are present or absent). Therefore, the training unit 162 extracts training data that satisfies such a condition from the list and thereby creates a training data set to be used in the training stage1.

Next, the training unit 162 performs, in order of training stage 1, training stage 2, training stage 3 and training stage 4, training in each of the stages until a predetermined end condition thereof is satisfied (steps S22 to S25). In the training in each of the stages, the error between the inference result of the inference task obtained as an output of the model 153 when the image included by the training data is input to the model 153 and the label information included by the training data is calculated using a pre-given loss function. There is a loss function for each of the object detection task, the pose estimation task, and the semantic segmentation estimation task. The loss function of the object detection task is denoted by L1, the loss function of the pose estimation task is denoted by L2, and the loss function of the semantic segmentation estimation task is denoted by L3.

In the training stage 1, the model 153 learns the parameters of the components CM2-1 and CM4-1 thereof to minimize a loss calculated with the loss function L1. In the training stage 2, the model 153 learns the parameters of the components CM2-1, CM2-2, CM4-1 and CM4-2 thereof to minimize the sum of the loss calculated with the loss function L1 and a loss calculated with the loss function L2 (e.g., weighted sum). In the training stage 2, the model 153 learns the parameters of the components CM2-1, CM2-2, CM2-3, CM4-1, CM4-2 and CM4-3 thereof to minimize the sum of the loss calculated with the loss function L1, the loss calculated with the loss function L2 and a loss calculated with the loss function L3 (e.g., weighted sum). In the training stage 4, the model 153 learns the parameters of the components CM-1, CM2-1, CM2-2, CM2-3, CM4-1, CM4-2 and CM4-3 thereof to minimize the sum of the loss calculated with the loss function L1, the loss calculated with the loss function L2 and the loss calculated with the loss function L3 (e.g., weighted sum). In each training, for example, the gradient descent method and the error backpropagation method may be used.

An example of the method for training the model 153 using training data has been described above. However, the training method applicable to the present invention is not limited to the above example. For example, the following training method may be applicable. That is to say, first, only the components CM2-1 and CM4-1 related to object detection are trained (the parameters of the other components CM1, CM2-2, CM2-3, CM4-2 and CM4-3 are fixed). Next, only the components CM2-2 and CM4-2 related to pose estimation are trained (the parameters of the other components CM1, CM2-1, CM2-3, CM4-1 and CM4-3 are fixed). Next, only the components CM2-3 and CM4-3 related to semantic segmentation estimation are trained (the parameters of the other components CM1, CM2-1, CM2-3, CM4-1 and CM4-3 are fixed). Next, only the components CM2-1 to CM2-3 and CM3-1 to CM3-3 related to all the inference tasks are trained (the parameter of the component CM1 is fixed). Next, the components CM1, CM2-1 to CM2-3, and CM4-1 to CM4-3 of the entire model are trained.

As described above, with the image processing apparatus 10 according to this example embodiment, it is possible to share among a plurality of tasks high-order feature values specific to the tasks. Therefore, in each of the tasks, training and estimation can be performed in consideration of a high-order feature value specific to the task and high-order feature values specific to the other tasks.

Subsequently, modified examples of this example embodiment will be described.

### Modified Example 1

In the example embodiment described above, the model 153 is configured to perform semantic segmentation estimation. However, the model 153 may be configured to perform instant semantic segmentation estimation, instead of semantic segmentation estimation. In this case, for example, a component that performs object detection from the feature value FM3-3 may be added between the component CM3 and the component CM4-3 of the multitask model 153 shown in FIG. 4, and the component CM4-3 may be configured to estimate, for each of the rectangles of the detected classes, a class in pixel units.

### Modified Example 2

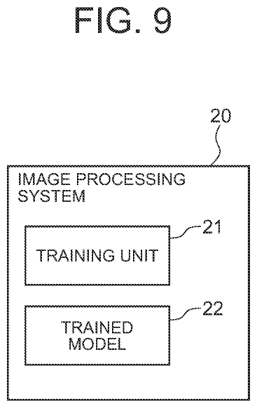

In the example embodiment described above, the model 153 is configured to perform three inference tasks including object detection, pose estimation, and semantic segmentation estimation. However, the model 153 may be configured to perform only two inference tasks among object detection, pose estimation, and semantic segmentation estimation. Alternatively, the inference tasks performed by the model 153 are not limited to object detection, pose estimation, and semantic segmentation estimation, and may be a task other than the above.

[Second Example Embodiment]FIG. 9 is a block diagram of an image processing system 20 according to a second example embodiment of the present invention. Referring to FIG. 9, the image processing system 20 includes a training unit 21 and a trained model 22.

The training unit 21 is configured to generate the trained model 22 that performs a plurality of mutually different inference tasks from an image. The training unit 21 can be configured, for example, in the same manner as the training unit 162 of FIG. 1, but is not limited thereto.

The trained model 22 is configured to include: a first component that extracts, from the image, a first feature value common to the plurality of inference tasks; a second component that is provided for each inference task and extracts, from the first feature value, a second feature value specific to the inference task; a third component that generates a third feature value by concatenating the second feature values extracted for the respective inference tasks; and a fourth component that is provided for each inference task and outputs an inference result of the inference task from the third feature value.

The image processing system 20 configured as described above operates in the following manner. That is to say, the training unit 21 generates the trained model 22 that performs a plurality of mutually different inference tasks from an image. In the generation, the training unit 21 causes the trained model 22 to: extract a first feature value common to the plurality of inference tasks from the image; then extract, for each inference task, a second feature value specific to the inference task from the first feature value; then generate a third feature value by concatenating the second feature values extracted for the respective inference tasks; and then output, for each inference task, an inference result of the inference task from the third feature value.

The image processing system 20 that is configured and operates in the above manner makes it possible to share, among a plurality of inference tasks, a feature value specific to each of the tasks. The reason is that the image processing system 20 is configured to generate the third feature value by concatenating the second feature values extracted for the respective inference tasks and output an inference result of the corresponding inference task from the third feature value.

Consequently, in each of the inference tasks, learning and estimation can be performed in consideration of a feature value specific to the task and feature values specific to the other tasks.

### [Third Example Embodiment]

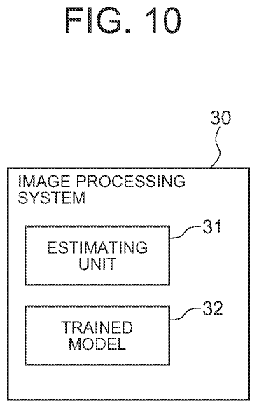

FIG. 10 is a block diagram of an image processing system 30 according to a third example embodiment of the present invention. Referring to FIG. 10, the image processing system 30 includes an estimating unit 31 and a trained model 32.

The estimating unit 31 is configured to, using the trained model 32, output inference results of a plurality of mutually different inference tasks from an image. The estimating unit 31 can be configured, for example, in the same manner as the estimating unit 163 of FIG. 1, but is not limited thereto.

The trained model 32 is configured to include: a first component that extracts, from the image, a first feature value common to the plurality of inference tasks; a second component that is provided for each of the inference tasks and extracts, from the first feature value, a second feature value specific to the inference task; a third component that generates a third feature value by concatenating the second feature values extracted for the respective inference tasks; and a fourth component that is provided for each of the inference tasks and outputs an inference result of the inference task from the third feature value.

The image processing system 30 configured as described above operates in the following manner. That is to say, the estimating unit 31 estimates, using the trained model 32, inference results of a plurality of mutually different inference tasks from an image. In the estimation, the estimating unit 31 causes the trained model 32 to: first extract the first feature value common to the plurality of inference tasks from the image; then extract, for each of the inference tasks, the second feature value specific to the inference task from the first feature value; then generate the third feature value by concatenating the second feature values extracted for the respective inference tasks; and then output, for each of the inference tasks, the inference result of the inference task from the third feature value.

The image processing system 30 that is configured and operates in the above manner makes it possible to share, among a plurality of inference tasks, a feature value specific to each of the tasks. The reason is that the image processing system 30 is configured to generate the third feature value by concatenating the second feature values extracted for the respective inference tasks and output the inference result of the inference task from the third feature value.

Consequently, in each of the inference tasks, learning and estimation can be performed in consideration of a feature value specific to the task and feature values specific to the other tasks.

Although the present invention has been described above with reference to the example embodiments, the present invention is not limited to the above example embodiments. The configurations and details of the present invention can be changed in various manners that can be understood by one skilled in the art within the scope of the present invention.

### INDUSTRIAL APPLICABILITY

The present invention can be used in all fields where a plurality of tasks such as object detection, pose estimation and semantic segmentation estimation are performed from an image such as a camera image.

The whole or part of the example embodiments disclosed above can be described as, but not limited to, the following supplementary notes.

### [Supplementary Note 1]

An image processing system comprising
a training unit that generates a trained model performing a plurality of mutually different inference tasks from an image,
wherein the trained model includes:
a first component that extracts a first feature value common to the plurality of inference tasks from the image;
a second component that is provided for each of the inference tasks and extracts a second feature value specific to the corresponding inference task from the first feature value;
a third component that generates a third feature value by concatenating the second feature values extracted for the respective inference tasks; and
a fourth component that is provided for each of the inference tasks and outputs an inference result of the corresponding inference task from the third feature value.

### [Supplementary Note 2]

The image processing system according to Supplementary Note 1, wherein
the third component sets one of the second feature values as a reference feature value, changes a size of the second feature value other than the reference feature value to match a size of the reference feature value, generates the third feature value by concatenating the second feature value other than the reference feature value after the change of the size and the reference feature value and, for each of the inference tasks, outputs the third feature value to the fourth component after changing a size of the third feature value to match an input size of the fourth component.

### [Supplementary Note 3]

The image processing system according to Supplementary Note 1, wherein
the third component includes a subcomponent corresponding to each of the inference tasks, and the subcomponent sets the second feature value of the corresponding inference task as a reference feature value, changes a size of the second feature value other than the second feature value of the corresponding inference task to match a size of the reference feature value, generates the third feature value by concatenating the second feature value other than the second feature value of the corresponding inference task after the change of the size and the reference feature value, and outputs the third feature value to the fourth component.

### [Supplementary Note 4]

The image processing system according to any of Supplementary Notes 1 to 3, wherein:
the training unit trains the trained model in a plurality of training stages; and
the plurality of training stages include at least:
a first training stage where any one of the plurality of inference tasks is set as a learning target task and, while parameters of the second component and the third component related to the inference task other than the learning target task and a parameter of the first component are fixed, parameters of the second component and the third component related to the learning target task are learned; and
a second training stage where, while the parameter of the first component is fixed, parameters of the second components and the third components related to all the inference tasks are learned.

### [Supplementary Note 5]

The image processing system according to any of Supplementary Notes 1 to 4, wherein
the fourth component provided for each of the inference tasks sets a weight defining a priority level of the second feature value of the corresponding inference task among the second feature values included by the third feature value to be larger than a weight defining a priority level of the other second feature value.

### [Supplementary Note 6]

The image processing system according to any of Supplementary Notes 1 to 5, wherein
the fourth component provided for each of the inference tasks performs 1×1 convolution on the input third feature value to reduce a number of dimensions of the third feature value.

### [Supplementary Note 7]

The image processing system according to any of Supplementary Notes 1 to 6, wherein
the plurality of inference tasks include an object detection task, a pose estimation task, and a semantic segmentation estimation task.)

### [Supplementary Note 8]

The image processing system according to any of Supplementary Notes 1 to 7, further comprising
an inferring unit that outputs inference results of the plurality of inference tasks from an image by using the trained model.

### [Supplementary Note 9]

An image processing system comprising
an inferring unit that outputs inference results of a plurality of mutually different inference tasks from an image by using a trained model,
wherein the trained model includes:
a first component that extracts a first feature value common to the plurality of inference tasks from the image;
a second component that is provided for each of the inference tasks and extracts a second feature value specific to the corresponding inference task from the first feature value;
a third component that generates a third feature value by concatenating the second feature values extracted for the respective inference tasks; and
a fourth component that is provided for each of the inference tasks and outputs an inference result of the corresponding inference task from the third feature value.

### [Supplementary Note 10]

An image processing method comprising:
generating a trained model performing a plurality of mutually different inference tasks from an image; and
in the generation, causing the trained model to:
extract a first feature value common to the plurality of inference tasks from the image;
extract, for each of the inference tasks, a second feature value specific to the corresponding inference task from the first feature value;
generate a third feature value by concatenating the second feature values extracted for the respective inference tasks; and
output, for each of the inference tasks, an inference result of the corresponding inference task from the third feature value.

### [Supplementary Note 11]

An image processing method comprising:
estimating and outputting inference results of a plurality of mutually different inference tasks from an image by using a trained model; and
in the estimation, causing the trained model to:
extract a first feature value common to the plurality of inference tasks from the image;
extract, for each of the inference tasks, a second feature value specific to the corresponding inference task from the first feature value;
generate a third feature value by concatenating the second feature values extracted for the respective inference tasks; and
output, for each of the inference tasks, an inference result of the corresponding inference task from the third feature value.

### [Supplementary Note 12]

A non-transitory computer-readable recording medium on which a program is recorded, the program comprising instructions for causing a computer to perform processes to:
generate a trained model performing a plurality of mutually different inference tasks from an image; and
in the generation, cause the trained model to:
extract a first feature value common to the plurality of inference tasks from the image;
extract, for each of the inference tasks, a second feature value specific to the corresponding inference task from the first feature value;
generate a third feature value by concatenating the second feature values extracted for the respective inference tasks; and
output, for each of the inference tasks, an inference result of the corresponding inference task from the third feature value.

### [Supplementary Note 13]

A non-transitory computer-readable recording medium on which a program is recorded, the program comprising instructions for causing a computer to perform processes to:
estimate and output inference results of a plurality of mutually different inference tasks from an image by using a trained model; and
in the estimation, causing the trained model to:
extract a first feature value common to the plurality of inference tasks from the image;
extract, for each of the inference tasks, a second feature value specific to the corresponding inference task from the first feature value;
generate a third feature value by concatenating the second feature values extracted for the respective inference tasks; and
output, for each of the inference tasks, an inference result of the corresponding inference task from the third feature value.

### REFERENCE SIGNS LIST

10 image processing apparatus

11 camera I/F unit

12 communication I/F unit

13 operation input unit

14 screen display unit

15 storing unit

16 operation processing unit

17 image server

18 camera

151 program

152 image information

153 model

154 estimation result information

161 acquiring unit

162 training unit

163 estimating unit

What is claimed is:

1. An image processing apparatus comprising:
a memory containing program instructions; and
a processor coupled to the memory, wherein the processor is configured to execute the program instructions to:
generate a trained model performing a plurality of mutually different inference tasks from an image,
wherein the trained model includes:
a first component that extracts a first feature value common to the plurality of inference tasks from the image;
a second component that is provided for each of the inference tasks and extracts a second feature value specific to the corresponding inference task from the first feature value;
a third component that generates a third feature value by concatenating the second feature values extracted for the respective inference tasks; and
a fourth component that is provided for each of the inference tasks and outputs an inference result of the corresponding inference task from the third feature value.

2. The image processing apparatus according to claim 1, wherein
the third component is configured to set one of the second feature values as a reference feature value, change a size of the second feature value other than the reference feature value to match a size of the reference feature value, generate the third feature value by concatenating the second feature value other than the reference feature value after the change of the size and the reference feature value and, for each of the inference tasks, output the third feature value to the fourth component after changing a size of the third feature value to match an input size of the fourth component.

3. The image processing apparatus according to claim 1, wherein
the third component includes a subcomponent corresponding to each of the inference tasks, and the subcomponent is configured to set the second feature value of the corresponding inference task as a reference feature value, change a size of the second feature value other than the second feature value of the corresponding inference task to match a size of the reference feature value, generate the third feature value by concatenating the second feature value other than the second feature value of the corresponding inference task after the change of the size and the reference feature value, and output the third feature value to the fourth component.

4. The image processing apparatus according to claim 1, wherein:
the processor is further configured to execute the instructions to, in the generation of the trained model, train the trained model in a plurality of training stages; and
the plurality of training stages include at least:
a first training stage where any one of the plurality of inference tasks is set as a learning target task and, while parameters of the second component and the fourth component related to the inference task other than the learning target task and a parameter of the first component are fixed, parameters of the second component and the fourth component related to the learning target task are learned; and
a second training stage where, while the parameter of the first component is fixed, parameters of the second components and the fourth components related to all the inference tasks are learned.

5. The image processing apparatus according to claim 1, wherein
the fourth component provided for each of the inference tasks is configured to set a weight defining a priority level of the second feature value of the corresponding inference task among the second feature values included by the third feature value to be larger than a weight defining a priority level of the other second feature value.

6. The image processing apparatus according to claim 1, wherein
the fourth component provided for each of the inference tasks is configured to perform 1×1 convolution on the input third feature value to reduce a number of dimensions of the third feature value.

7. The image processing apparatus according to claim 1, wherein
the plurality of inference tasks include an object detection task, a pose estimation task, and a semantic segmentation estimation task.

8. The image processing apparatus according to claim 1, wherein the processor is further configured to execute the instructions to
output inference results of the plurality of inference tasks from an image by using the trained model.

9. (canceled)

10. An image processing method by a computer, comprising:
generating a trained model performing a plurality of mutually different inference tasks from an image
wherein, in the generation, the computer causes the trained model to:
extract a first feature value common to the plurality of inference tasks from the image;
extract, for each of the inference tasks, a second feature value specific to the corresponding inference task from the first feature value;
generate a third feature value by concatenating the second feature values extracted for the respective inference tasks; and
output, for each of the inference tasks, an inference result of the corresponding inference task from the third feature value.

11. (canceled)

12. A non-transitory computer-readable recording medium on which a program is recorded, the program comprising instructions for causing a computer to perform processes to:
generate a trained model performing a plurality of mutually different inference tasks from an image; and
in the generation, cause the trained model to:
extract a first feature value common to the plurality of inference tasks from the image;
extract, for each of the inference tasks, a second feature value specific to the corresponding inference task from the first feature value;
generate a third feature value by concatenating the second feature values extracted for the respective inference tasks; and
output, for each of the inference tasks, an inference result of the corresponding inference task from the third feature value.

13. (canceled)
